(19) United States
(12) Patent Application Publication
(10) Pub. No.: US 2020/0364170 A1
(43) Pub. Date: Nov. 19, 2020

(54) INTEGRATED ELECTRONIC APPARATUS FOR DATA ACCESS, DATA TRANSMISSION AND POWER MANAGEMENT AND METHOD THEREOF

(71) Applicant: GENESYS LOGIC, INC., New Taipei City (TW)

(72) Inventor: Yao-chung Hu, New Taipei City (TW)

(21) Appl. No.: 15/930,522

(22) Filed: May 13, 2020

(30) Foreign Application Priority Data
May 17, 2019 (TW) 108117174

(51) Int. Cl. G06F 13/40; G06F 13/42; G06F 1/26

(52) U.S. Cl. CPC G06F 13/4022; G06F 2213/0042; G06F 1/266; G06F 13/4282

(57) ABSTRACT

An integrated electronic apparatus for data access, data transmission, and power management and method thereof are provided. The integrated electronic apparatus employs a first controller, a second controller, and a switch unit for controlling the data access, data transmission, and power management between a first peripheral device and a second peripheral device, so that a first communication interface and a second communication interface of the integrated electronic apparatus are integrated effectively to increase convenience of the data access and utilization flexibility of the integrated electronic apparatus. The integrated electronic apparatus serves as functions of a portable storage device, a data transmission line, and a portable power bank.

### CROSS REFERENCE TO RELATED APPLICATION

This application claims priority to Taiwan Application Serial No. 108117174, filed May 17, 2019, the disclosure of which is incorporated herein by reference.

### FIELD OF DISCLOSURE

The present disclosure relates to an electronic device and method thereof, and in particularly to an integrated electronic apparatus for data access, data transmission, and power management and method thereof.

### BACKGROUND

With rapid development of information technologies, applications of electronic products have become increasingly popular. For example, portable electronic devices such as notebooks, mobile phones, and tablets are everywhere. These electronic devices are characterized by being portable and ready to use anywhere. In order to enable various electronic devices to be connected to each other for a relatively large amount of data transmission, it is common to insert a flash drive with a universal serial bus (USB) connector into the electronic product to expand a memory storage capacity of the electronic product. Alternatively, the electronic product is connected to another electronic product by a cable having a USB port to perform a data transmission between these two electronic products. However, due to a difference in types of a connector (such as a standard USB Type-A connector) and a USB port (such as a lightning connector defined by Apple Inc.), the flash drive with the connector and the cable are difficult to integrate. Furthermore, the flash drive not only does not have a power supply function, but also limits the application with a USB flash drive. Accordingly, it is necessary to provide a new electronic device to solve the technical problem in the prior art.

### SUMMARY OF DISCLOSURE

An object of the present disclosure is to provide an integrated electronic apparatus for data access, data transmission, and power management and a method thereof. The integrated electronic apparatus employs a first controller, a second controller, and a switch unit for controlling the data access, data transmission, and power management between a first peripheral device and a second peripheral device, so that a first communication interface and a second communication interface of the integrated electronic apparatus are integrated effectively to increase convenience of the data access and utilization flexibility of the integrated electronic apparatus. The integrated electronic apparatus serves as functions of a portable storage device, a data transmission line, and a portable power bank.

In order to achieve the above object, the present disclosure provides an integrated electronic apparatus for data access, data transmission, and power management. The integrated electronic apparatus includes a storage unit, a power module, a first communication interface, a second communication interface, a switch unit, a first controller, and a second controller. The storage unit is configured to store data. The power module is configured to supply power. The first communication interface is configured to detect whether a first peripheral device is connected thereto, so as to determine a corresponding communication connection between the storage unit and the power module and the first peripheral device. The second communication interface is configured to detect whether a second peripheral device is connected thereto, so as to determine another corresponding communication connection between the storage unit and the power module and the second peripheral device. The switch unit is coupled to the storage unit, the first communication interface, and the second communication interface, and is configured to switch a connection state between the storage unit, the first communication interface, and the second communication interface. The first controller is coupled to the storage unit, the first communication interface, the second communication interface, and the switch unit, and is configured to control the switch unit to perform switching between the storage unit, the first communication interface, and the second communication interface. The second controller is coupled to the power module, the first communication interface, the second communication interface, and the switch unit. The first controller controls the first peripheral device to access first data corresponding to the storage unit according to a first protocol, and/or controls the second peripheral device to access the first data corresponding to the storage unit according to a second protocol. The second controller controls the first peripheral device to charge the power module, and/or controls the power module to supply the power to the second peripheral devices.

In one embodiment, in response to the first peripheral device connecting to the first communication interface, the first controller controls the switch unit to connect the storage unit to the first communication interface, such that the first peripheral device reads and writes the first data of the storage unit according to the first protocol, and the second controller controls the first communication interface to enable the first peripheral device to charge the power module.

In one embodiment, the first peripheral device is in a host mode, and the integrated electronic apparatus is in a device mode.

In one embodiment, in response to the second peripheral device connecting to the second communication interface, the first controller controls the switch unit to connect the storage unit to the second communication interface, such that the second peripheral device reads and writes the first data of the storage unit according to the second protocol, and the second controller controls the second communication interface to enable the power module to supply the power to the second peripheral device.

In one embodiment, in response to the power module supplying the power to the second peripheral device for charging, the integrated electronic apparatus is in a host mode, and the second peripheral device is in a device mode, and in response to the second peripheral device reading and writing the first data, the integrated electronic apparatus is in the device mode, and the second peripheral device is in the host mode.

In one embodiment, in response to the first peripheral device connecting to the first communication interface and the second peripheral device connecting to the second communication interface, the second controller controls the switch unit to connect the first communication interface to the second communication interface, such that the first peripheral device extracts second data of the second peripheral device according to the second protocol, and the second controller controls the first communication interface to enable the first peripheral device to charge the power module, and the second controller controls the second communication interface to enable the power module to supply the power to the second peripheral device.

In one embodiment, the first peripheral device is in a host mode, and the second peripheral device is in a device mode.

In one embodiment, in response to the first peripheral device connecting to the first communication interface and the second peripheral device connecting to the second communication interface, the first controller controls the switch unit to connect the storage unit to the second communication interface, such that the second peripheral device reads and writes the first data of the storage unit according to the second protocol, and the second controller controls the first communication interface to enable the first peripheral device to charge the power module, and the second controller controls the second communication interface to enable the power module to supply the power to the second peripheral device.

In one embodiment, in response to the power module supplying the power to the second peripheral device, the integrated electronic apparatus is in a host mode, and the second peripheral device is in a device mode, and in response to the second peripheral device reading and writing the first data, the integrated electronic apparatus is in the device mode, and the second peripheral device is in the host mode.

In one embodiment, the storage unit includes a secure digital memory card or an embedded multimedia card.

In one embodiment, the first protocol includes a universal serial bus (USB) mass storage class protocol.

In one embodiment, the second protocol includes an iPod accessory protocol.

The present disclosure also provides an implementation method of an integrated electronic apparatus for data access, data transmission, and power management. The integrated electronic apparatus includes a storage unit, a power module, a first communication interface, a second communication interface, a switch unit, a first controller, and a second controller. The implementation method includes the following steps.

S1, detecting whether the first communication interface is connected to a first peripheral device to determine a corresponding communication connection between the storage unit and the power module and the first peripheral device;

S2, detecting whether the second communication interface is connected to a second peripheral device to determine another corresponding communication connection between the storage unit and the power module and the second peripheral device;

S3, switching, by the switch unit, a connection state between the storage unit, the first peripheral device, and the second peripheral device according to detection results of the first communication interface and the second communication interface;

S4, controlling, by the second controller, a charging state and a powering state between the power module, the first peripheral device, and the second peripheral device according to the detection results of the first communication interface and the second communication interface;

S5, controlling, by the first controller, the first peripheral device to access first data corresponding to the storage unit according to a first protocol, and/or controlling, by the first controller, the second peripheral device to access the first data corresponding to the storage unit according to a second protocol; and

S6, controlling, by the second controller, the first peripheral device to charge the power module, and/or controlling, by the second controller, the power module to supply power to the second peripheral devices.

In one embodiment, in the step S5, if the first peripheral device is connected to the first communication interface, the first controller controls the first peripheral device to read and write the first data of the storage unit according to the first protocol, and in the step S6, the second controller controls the first peripheral device to charge the power module.

In one embodiment, the first peripheral device is in a host mode, and the integrated electronic apparatus is in a device mode.

In one embodiment, in the step S5, if the second peripheral device is connected to the second communication interface, the first controller controls the second peripheral device to read and write the first data of the storage unit according to the second protocol, and in the step S6, the power module is controlled to supply the power to the second peripheral device.

In one embodiment, if the power module supplies the power to the second peripheral device for charging, the integrated electronic apparatus is in a host mode and the second peripheral device is in a device mode, and if the second peripheral device reads and writes the first data, the integrated electronic apparatus is in the device mode and the second peripheral device is in host mode.

In one embodiment, in the step S5, if the first peripheral device is connected to the first communication interface and the second peripheral device is connected to the second communication interface, the second controller controls the switch unit to enable the first peripheral device to extract second data of the second peripheral device according to the second protocol, and in the step S6, the second controller controls the first communication interface to enable the first peripheral device to charge the power module, and the second controller controls the second communication interface to enable the power module to supply the power to the second peripheral device.

In one embodiment, the first peripheral device is in a host mode, and the second peripheral device is in a device mode.

In one embodiment, in the step S5, if the first peripheral device is connected to the first communication interface and the second peripheral device is connected to the second communication interface, the first controller controls the switch unit to connect the storage unit to the second communication interface, such that the second peripheral device accesses the first data corresponding to the storage unit according to the second protocol, and in the step S6, the second controller controls the first communication interface to enable the first peripheral device to charge the power module, and the second controller controls the second communication interface to enable the power module to supply the power to the second peripheral device.

In one embodiment, if the power module supplies the power to the second peripheral device, the integrated electronic apparatus is in a host mode and the second peripheral device is in a device mode, and if the second peripheral device reads and writes the first data, the integrated electronic apparatus is in the device mode, and the second peripheral device is in the host mode.

In one embodiment, the first protocol includes a universal serial bus (USB) mass storage class protocol.

In one embodiment, the second protocol includes an iPod accessory protocol.

### BRIEF DESCRIPTION OF DRAWINGS

In order to illustrate the technical solutions according to the embodiments of the present disclosure more clearly, the accompanying drawings for describing the embodiments are introduced briefly in the following. Apparently, the accompanying drawings in the following description are only some embodiments of the present disclosure, and persons of ordinary skill in the art may derive other drawings from the accompanying drawings without creative efforts.

FIG. 1 is a block diagram showing an integrated electronic apparatus for data access, data transmission, and power management according to a first embodiment of the present disclosure.

FIG. 2 is a block diagram showing an integrated electronic apparatus for data access, data transmission, and power management according to a second embodiment of the present disclosure.

FIG. 3 is a block diagram showing an integrated electronic apparatus for data access, data transmission, and power management according to a third embodiment of the present disclosure.

FIG. 4 is a block diagram showing an integrated electronic apparatus for data access, data transmission, and power management according to a fourth embodiment of the present disclosure.

FIG. 5 is a flowchart showing an implementation method of an integrated electronic apparatus for data access, data transmission, and power management according to an embodiment of the present disclosure.

FIG. 6 is a flowchart showing a conversion method of a host mode and a device mode between an integrated electronic apparatus and peripheral devices according to an embodiment of the present disclosure.

### DETAILED DESCRIPTION

Please refer to the drawings, like reference numerals designate like elements throughout the specification. The principle of the present disclosure is described by the embodiments in suitable operation conditions. The following description is based on the specific illustrated embodiments of the present disclosure, which should not be construed as limiting the present disclosure, unless otherwise specified.

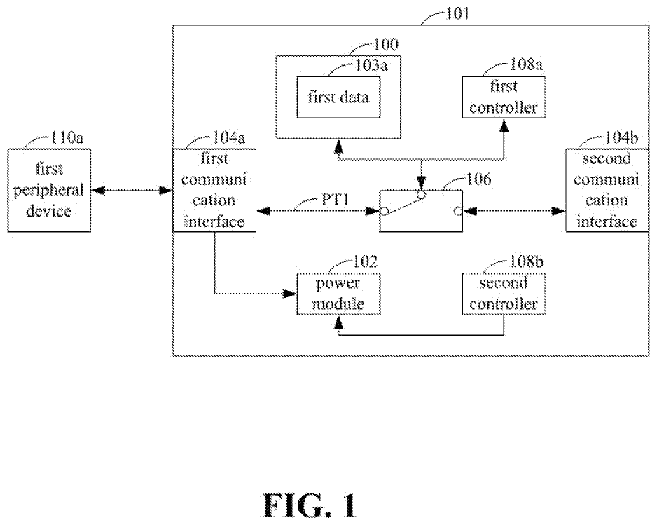

Please refer to FIG. 1, which is a block diagram showing an integrated electronic apparatus 101 for data access, data transmission, and power management according to a first embodiment of the present disclosure. The integrated electronic apparatus 101 includes a storage unit 100, a power module 102, a first communication interface 104a, a second communication interface 104b, a switch unit 106, a first controller 108a, and a second controller 108b. The first communication interface 104a is, for example, a standard USB Type-A port or a micro-USB Type-A port, and the second communication interface 104b is, for example, a B-type lightning connector defined by Apple Inc.

As shown in FIG. 1, the storage unit 100 is configured to store data content for peripheral devices to read the data content or write the data content. In one embodiment, the storage unit 100 is a secure digital (SD) memory card or an embedded multimedia card (eMMC). The power module 102 is configured to supply power. The power servers as a power source for the integrated electronic apparatus 101 to operate, or is supplied to a peripheral device. Alternatively, another peripheral device can charge the power module 102.

As shown in FIG. 1, the first communication interface 104a is configured to detect whether a first peripheral device 110a is connected thereto, to determine a correspondingly communication connection between the storage unit 100 and the power module 102 and the first peripheral device 110a. The second communication interface 104b is configured to detect whether a second peripheral device is connected thereto, to determine another correspondingly communication connection between the storage unit 100 and the power module 102 and the second peripheral device 110a. In this case, the second communication interface 104b is not connected to the second peripheral device. The switch unit 106 is coupled to the storage unit 100, the first communication interface 104a, and the second communication interface 104b, and is configured to switch a connection state between the storage unit 100, the first communication interface 104a, and the second communication interface 104b. In one embodiment, the first peripheral device 110a is, for example, a notebook or a mobile phone having an Android operating system. In a preferred embodiment, the first peripheral device 110a is in a host mode, and the integrated electronic device 101 is in the host mode or a device mode. When the first peripheral device 110a is connected, the integrated electronic apparatus 101 is in the device mode. The host mode refers to a state in which the peripheral device can access the data content of the storage unit 100, that is, the peripheral device has a permission to read and write the data content of the storage unit 100. The device mode refers to a state in which the storage unit 100 is read and written by the peripheral device.

As shown in FIG. 1, the first controller 108a is coupled to the storage unit 100, the first communication interface 104a, the second communication interface 104b, and the switch unit 106, and is configured to control the switch unit to perform switching between the storage unit, the first communication interface, and the second communication interface. The second controller 108b is coupled to the power module 102, the first communication interface 104a, the second communication interface 104b, and the switch unit 106. The first controller 108a controls the first peripheral device 110a to access first data 103a corresponding to the storage unit 100 according to a first protocol PT1. Also, the second controller 108b controls the first peripheral device 110a to charge the power module 102.

Specifically, in FIG. 1, if the first peripheral device 110a is connected to the first communication interface 104a, the first controller 108a controls the switch unit 106 to connect the storage unit 100 to the first communication interface 104a, such that the first peripheral device 110a reads the first data 103a of the storage unit 100 or writes the first data 103a into the storage unit 100 according to the first protocol PT1. In other words, the first peripheral device 110a is in the host mode and the integrated electronic apparatus 101 is in the device mode. That is, the first peripheral device 110a regards the integrated electronic apparatus 101 as an external storage device such that the first peripheral device 110a can directly access the storage unit 100 of the integrated electronic apparatus 101. The first protocol PT1 is, for example, a universal serial bus (USB) mass storage class (MSC) protocol. When the first peripheral device 110a is connected to the first communication interface 104a, the second controller 108b controls the first communication interface 104a to enable the first peripheral device 110a to charge the power module 102. That is, the first peripheral device 110a functions as a charging power source of the power module 102 of the integrated electronic apparatus 101.

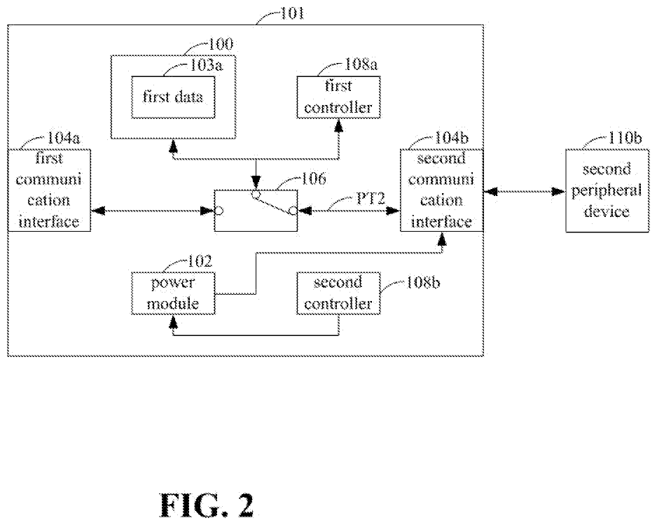

Please refer to FIG. 2, which is a block diagram showing an integrated electronic apparatus 101 for data access, data transmission, and power management according to a second embodiment of the present disclosure. When a second peripheral device 110b is connected to a second communication interface 104b, a first controller 108a controls a switch unit 106 to connect a storage unit 100 to the second communication interface 104b, so that the second peripheral device 110b reads first data 103a of the storage unit 100 or writes the first data 103a into the storage unit 100 according to a second protocol PT2. In an embodiment, the second protocol PT2 is, for example, an iPod accessory protocol (iAP) defined by Apple Inc. Moreover, if the second peripheral device 110b is connected to the second communication interface 104b, a second controller 108b controls the second communication interface 104b to enable a power module 102 to supply the power to the second peripheral device 110b. The integrated electronic apparatus 101 serves as a power supply source for the second peripheral device 110b. In the integrated electronic apparatus 101 of the second embodiment, a first communication interface 104a is not connected to a first peripheral device.

Specifically, in FIG. 2, if the power module 102 supplies the power to the second peripheral device 110b for charging, the integrated electronic apparatus 101 is in a host mode and the second peripheral device 110b is in a device mode. In addition, if the second peripheral device 110b reads and writes the first data 103a, the integrated electronic apparatus 101 is converted from the host mode to the device mode, and the second peripheral device 110b is converted from the device mode to the host mode. At this time, the second peripheral device 110b regards the integrated electronic apparatus 101 as an external storage device, so that the second peripheral device 110b can directly access the storage unit 100 of the integrated electronic apparatus 101. In one embodiment, the second peripheral device 110b is, for example, an iPhone or an iPad tablet manufactured by Apple Inc., but is not limited thereto, and is, for example, any peripheral device having the second protocol PT2 that complies with the iPod accessory protocol.

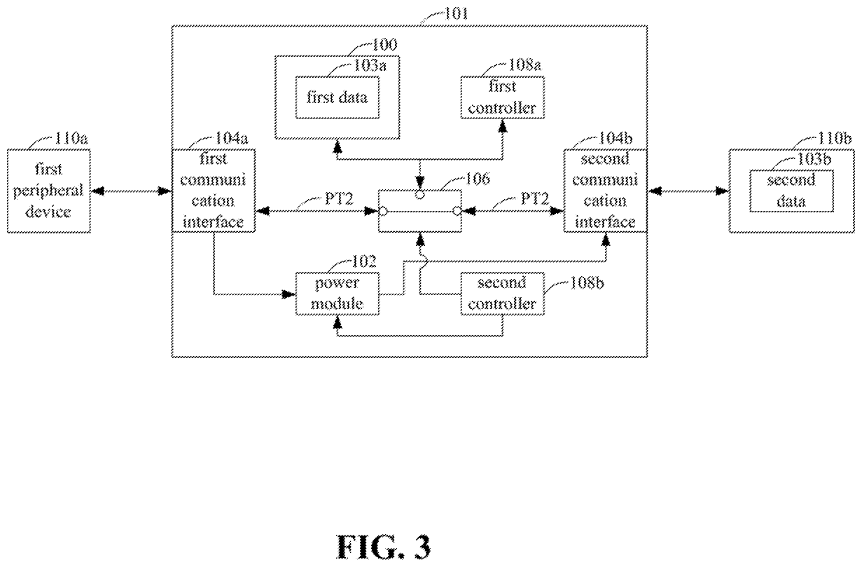

Please refer to FIG. 3, which is a block diagram showing an integrated electronic apparatus 101 for data access, data transmission, and power management according to a third embodiment of the present disclosure. When a first peripheral device 110a is connected to a first communication interface 104a and a second peripheral device 110b is connected to a second communication interface 104b, a second controller 108b controls a switch unit 106 to connect the first communication interface 104a to the second communication interface 104b, so that the first peripheral device 110a extracts second data 103b of the second peripheral device 110b according to a second protocol PT2. At this time, if the first peripheral device 110a is connected to the first communication interface 104a and the second peripheral device 110b is connected to the second communication interface 104b, the second controller 108b controls the first communication interface 104a to enable the first peripheral device 110a to charge a power module 102. Also, the second controller 108b controls the second communication interface 104b to enable the power module 102 to supply the power to the second peripheral device 110b. That is, the first peripheral device 110a functions as a charging power source of the power module 102 of the integrated electronic apparatus 101. Furthermore, the integrated electronic apparatus 101 serves as a power supply for the second peripheral device 110b. In the integrated electronic apparatus 101 of the third embodiment, the first communication interface 104a is connected to the first peripheral device 110a, and the second communication interface 104b is connected to the second peripheral device 110b.

Specifically, the first peripheral device 110a is in a host mode, and the second peripheral device 110b is in a device mode. That is, the first peripheral device 110a regards the second peripheral device 110b as an external storage device, so that the first peripheral device 110a can synchronously transmit a data content of the second peripheral device 110b. In one embodiment, the first peripheral device 110a copies the second data 103b of the second peripheral device 110b through the integrated electronic apparatus 101 according to the iPod accessory protocol (iAP) of the second protocol PT2. In other words, the integrated electronic apparatus 101 of the present disclosure has as a function of a data transmission line.

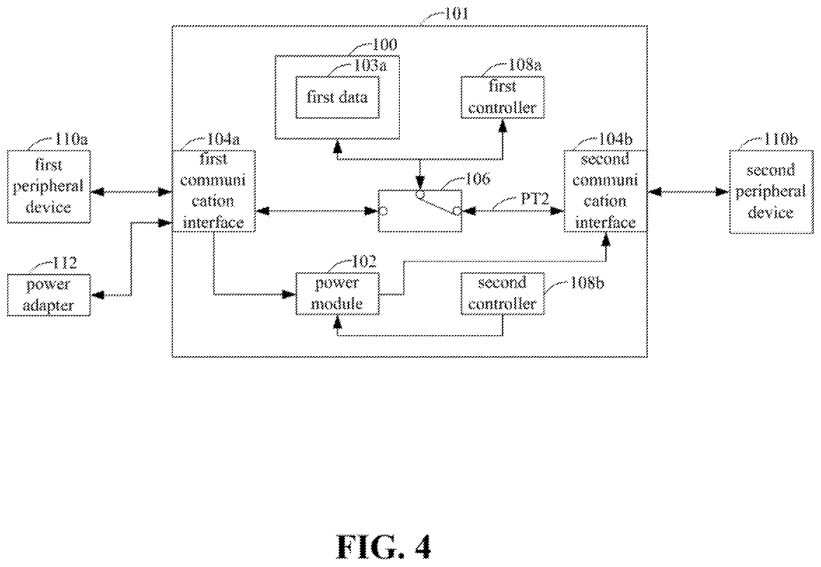

Please refer to FIG. 4, which is a block diagram showing an integrated electronic apparatus 101 for data access, data transmission, and power management according to a fourth embodiment of the present disclosure. When a first peripheral device 110a is connected to a first communication interface 104a and a second peripheral device 110b is connected to a second communication interface 104b, a first controller 108a controls a switch unit 106 to connect a storage unit 100 to the second communication interface 104b, such that the second peripheral device 110b reads first data 103a of the storage unit 100 or writes the first data 103a into the storage unit 100 according to a second protocol PT2. In one embodiment, the second protocol PT2 is, for example, an iPod accessory protocol (iAP). At this time, if the first peripheral device 110a is connected to the first communication interface 104a and the second peripheral device 110b is connected to the second communication interface 104b, a second controller 108b controls the first communication interface 104a to enable the first peripheral device 110a to charge a power module 102. That is, the first peripheral device 110a is a charging power source of the power module 102 of the integrated electronic apparatus 101, and the first peripheral device 110a is, for example, a notebook or a power adapter 112 connected to an external power source. Also, the second controller 108b controls the second communication interface 104b to enable the power module 102 to supply the power to the second peripheral device 110b. That is, the integrated electronic apparatus 101 serves as a power supply source for the second peripheral device 110b. In the integrated electronic apparatus 101 of the fourth embodiment, the first communication interface 104a is connected to the first peripheral device 110a, and the second communication interface 104b is connected to the second peripheral device 110b.

Specifically, if the power module 102 supplies the power to the second peripheral device 110b, the integrated electronic apparatus 101 is in a host mode and the second peripheral device 110b is in a device mode. However, if the second peripheral device 110b reads and writes the first data 103a, the integrated electronic apparatus 101 is converted from the host mode to the device mode, and the second peripheral device 110b is converted from the device mode to the host mode. At this time, the second peripheral device 110b regards the integrated electronic apparatus 101 as an external storage device, so that the second peripheral device 110b can directly access the storage unit 100 of the integrated electronic apparatus 101. In one embodiment, the second peripheral device 110b is, for example, an iPhone or an iPad tablet manufactured by Apple Inc. having an iPod accessory protocol (iAP). In this case, if the integrated electronic apparatus 101 is in the device mode, it serves as a storage device for the second peripheral device 110b. When the integrated electronic apparatus 101 is in the host mode, it serves as a power supply for the second peripheral device 110b. In another embodiment, the second peripheral device 110b is, for example, a mobile phone with an Android operating system. At this time, the integrated electronic apparatus 101 only serves as the power supply.

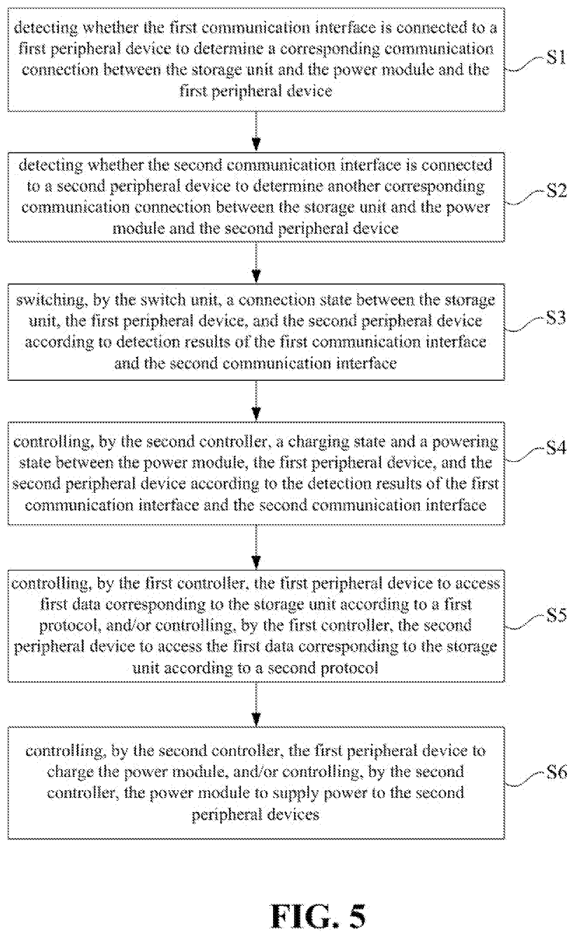

Please refer to FIG. 1 to FIG. 5, where FIG. 5 is a flowchart showing an implementation method of an integrated electronic apparatus 101 for data access, data transmission, and power management according to an embodiment of the present disclosure. The integrated electronic apparatus 101 includes a storage unit 100, a power module 102, a first communication interface 104a, a second communication interface 104b, a switch unit 106, a first controller 108a, and a second controller 108b. The implementation method includes the following steps.

In a step S1, the first communication interface 104a is detected whether a first peripheral device 110a is connected thereto, so as to determine a corresponding communication connection between the storage unit 100 and the power module 102 and the first peripheral device 110a.

In a step S2, the second communication interface 104b is detected whether a second peripheral device 110b is connected thereto, so as to determine another corresponding communication connection between the storage unit 100 and the power module 102 and the second peripheral device 110b.

In a step S3, according to detection results of the first communication interface 104a and the second communication interface 104b, the switch unit 106 switches a connection state between the storage unit 100, the first peripheral device 110a, and the second peripheral device 110b according to detection results of the first communication interface and the second communication interface.

In a step S4, according to the detection results of the first communication interface 104a and the second communication interface 104b, the second controller 108b controls a charging state and a powering state between the power module 102, the first peripheral device 110a, and the second peripheral device 110b.

In a step S5, the first controller 108a controls the first peripheral device 110a to access first data 103a corresponding to the storage unit 100 according to a first protocol PT1, and/or the first controller 108a controls the second peripheral device 110b to access the first data 103a corresponding to the storage unit 100 according to a second protocol PT2.

In a step S6, the second controller 108b controls the first peripheral device 110a to charge the power module 102, and/or the second controller 108b controls the power module 102 to supply power to the second peripheral devices 110b. In an embodiment, the first protocol PT1 is a universal serial bus (USB) mass storage class protocol, and the second protocol PT2 is an iPod accessory protocol.

As shown in FIG. 1 to FIG. 5, in the step S5, if the first peripheral device is connected to the first communication interface 104a, the first controller 108a controls the first peripheral device 110a to read and write the first data 103a of the storage unit 100 according to the first protocol PT1. Also, in the step S6, the second controller 108b controls the first peripheral device 110a to charge the power module 102. The first peripheral device 110a is in a host mode, and the integrated electronic apparatus 101 is in a device mode.

As shown in FIG. 2 to FIG. 5, in the step S5, if the second peripheral device is connected to the second communication interface 104b, the first controller 108a controls the second peripheral device 110b to read and write the first data 103a of the storage unit 100 according to the second protocol PT2. Also, in the step S6, the power module 102 is controlled to supply the power to the second peripheral device 110b. When the power module 102 supplies the power to the second peripheral device 110b for charging, the integrated electronic apparatus 101 is in the host mode and the second peripheral device 110b is in the device mode. When the second peripheral device 110b reads and writes the first data 103a, the integrated electronic apparatus 101 is in the device mode and the second peripheral device 110b is in the host mode.

As shown in FIG. 3 to FIG. 5, in the step S5, if the first peripheral device is connected to the first communication interface 104a and the second peripheral device is connected to the second communication interface 104b, the second controller 108b controls the switch unit 106to enable the first peripheral device 110a to extract second data 103b of the second peripheral device 110b according to the second protocol PT2. Also, in the step S6, the second controller 108b controls the first communication interface 104a to enable the first peripheral device 110a to charge the power module 102, and the second controller 108b controls the second communication interface 104b to enable the power module 102 to supply the power to the second peripheral device 110b. The first peripheral device 110a is in the host mode, and the second peripheral device 110b is in the device mode.

As shown in FIG. 4 to FIG. 5, in the step S5, the first peripheral device is connected to the first communication interface 104a and the second peripheral device is connected to the second communication interface 104b, the first controller 108a controls the switch unit 106 to connect the storage unit 100 to the second communication interface 104b, such that the second peripheral device 110b accesses the first data 103a corresponding to the storage unit 100 according to the second protocol PT2. Also, in the step S6, the second controller 108b controls the first communication interface 104a to enable the first peripheral device 110a to charge the power module 102, and the second controller 108b controls the second communication interface 104b to enable the power module 102 to supply the power to the second peripheral device 110b. When the power module 102 supplies the power to the second peripheral device 110b, the integrated electronic apparatus 101 is in the host mode and the second peripheral device 110b is in the device mode. When the second peripheral device 110b reads and writes the first data 103a, the integrated electronic apparatus 101 is in the device mode and the second peripheral device 110b is in the host mode.

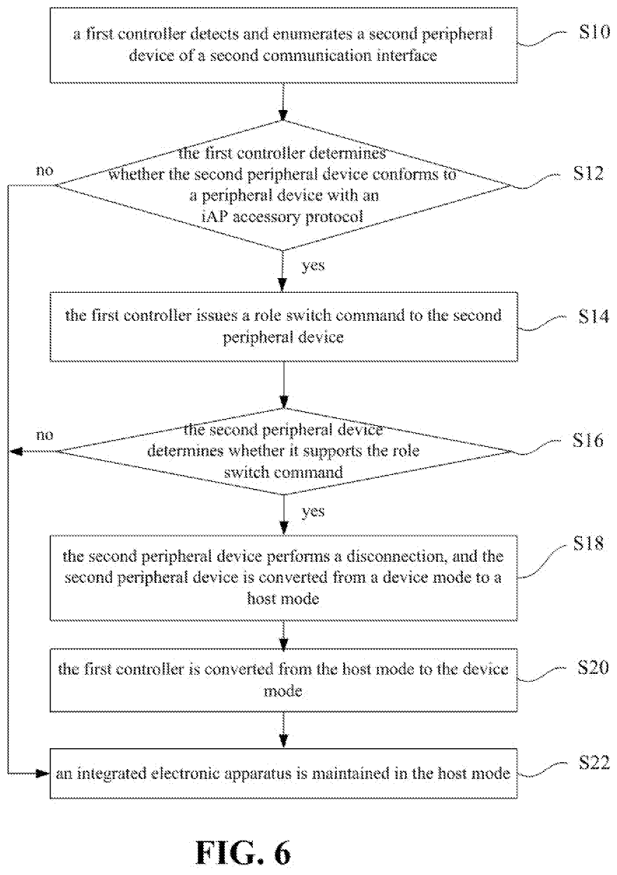

Refer to FIG. 2, FIG. 4, and FIG. 6, where FIG. 6 is a flowchart showing a conversion method of a host mode and a device mode between an integrated electronic apparatus 101 and peripheral devices according to an embodiment of the present disclosure. The integrated electronic apparatus 101 includes a storage unit 100, a power module 102, a first communication interface 104a, a second communication interface 104b, a switch unit 106, a first controller 108a, and a second controller 108b. The conversion method includes the following steps.

In a step S10, the first controller 108a detects and enumerates a second peripheral device of a second communication interface.

In a step S12, the first controller 108a determines whether the second peripheral device 110b conforms to a peripheral device with an iAP accessory protocol, and if yes, a step S14 is performed, and if no, a step S22 is performed.

In a step S14, the first controller 108a issues a role switch command to the second peripheral device 110b, and the role switch command is, for example, a USB custom vendor request command.

In a step S16, the second peripheral device 110b determines whether it supports the role switch command, and if yes, a step S18 is performed, and if no, the step S22 is performed.

In a step S18, the second peripheral device 110b performs a disconnection, and the second peripheral device 110b is converted from the device mode to the host mode.

In a step S20, the first controller 108a is converted from the host mode to the device mode.

In the step S22, the integrated electronic apparatus 101 is maintained in the host mode.

In summary, in integrated electronic apparatus 101 for data access, data transmission, and power management and method thereof of the present disclosure, the first controller, the second controller, and the switch unit are configured to control the data access, data transmission, and power management between the first peripheral device and the second peripheral device, such that the first communication interface and the second communication interface of the integrated electronic apparatus 101 are integrated to increase an application range of the storage device and improve the utilization flexibility of the storage device.

The preferable embodiments of the present disclosure have been described above, and are not intended to limit the scope of the present disclosure. Any modification or replacement made by those skilled in the art without departing from the spirit and principle of the present disclosure should fall within the protection scope of the present disclosure, and scope of the present disclosure as defined by the appended claims.

What is claimed is:

1. An integrated electronic apparatus for data access, data transmission, and power management, comprising:
a storage unit configured to store data;
a power module configured to supply power;
a first communication interface configured to detect whether a first peripheral device is connected thereto, so as to determine a corresponding communication connection between the storage unit and the power module and the first peripheral device;
a second communication interface configured to detect whether a second peripheral device is connected thereto, so as to determine another corresponding communication connection between the storage unit and the power module and the second peripheral device;
a switch unit coupled to the storage unit, the first communication interface, and the second communication interface, and configured to switch a connection state between the storage unit, the first communication interface, and the second communication interface;
a first controller coupled to the storage unit, the first communication interface, the second communication interface, and the switch unit, and configured to control the switch unit to perform switching between the storage unit, the first communication interface, and the second communication interface; and
a second controller coupled to the power module, the first communication interface, the second communication interface, and the switch unit;
wherein the first controller controls the first peripheral device to access first data corresponding to the storage unit according to a first protocol, and/or controls the second peripheral device to access the first data corresponding to the storage unit according to a second protocol; and
the second controller controls the first peripheral device to charge the power module, and/or controls the power module to supply the power to the second peripheral devices.

2. The integrated electronic apparatus for data access, data transmission, and power management as claimed in claim 1, wherein in response to the first peripheral device connecting to the first communication interface, the first controller controls the switch unit to connect the storage unit to the first communication interface, such that the first peripheral device reads and writes the first data of the storage unit according to the first protocol, and the second controller controls the first communication interface to enable the first peripheral device to charge the power module.

3. The integrated electronic apparatus for data access, data transmission, and power management as claimed in claim 2, wherein the first peripheral device is in a host mode, and the integrated electronic apparatus is in a device mode.

4. The integrated electronic apparatus for data access, data transmission, and power management as claimed in claim 1, wherein in response to the second peripheral device connecting to the second communication interface, the first controller controls the switch unit to connect the storage unit to the second communication interface, such that the second peripheral device reads and writes the first data of the storage unit according to the second protocol, and the second controller controls the second communication interface to enable the power module to supply the power to the second peripheral device.

5. The integrated electronic apparatus for data access, data transmission, and power management as claimed in claim 4, wherein in response to the power module supplying the power to the second peripheral device for charging, the integrated electronic apparatus is in a host mode, and the second peripheral device is in a device mode, and in response to the second peripheral device reading and writing the first data, the integrated electronic apparatus is in the device mode, and the second peripheral device is in the host mode.

6. The integrated electronic apparatus for data access, data transmission, and power management as claimed in claim 1, wherein in response to the first peripheral device connecting to the first communication interface and the second peripheral device connecting to the second communication interface, the second controller controls the switch unit to connect the first communication interface to the second communication interface, such that the first peripheral device extracts second data of the second peripheral device according to the second protocol, and the second controller controls the first communication interface to enable the first peripheral device to charge the power module, and the second controller controls the second communication interface to enable the power module to supply the power to the second peripheral device.

7. The integrated electronic apparatus for data access, data transmission, and power management as claimed in claim 6, wherein the first peripheral device is in a host mode, and the second peripheral device is in a device mode.

8. The integrated electronic apparatus for data access, data transmission, and power management as claimed in claim 1, wherein in response to the first peripheral device connecting to the first communication interface and the second peripheral device connecting to the second communication interface, the first controller controls the switch unit to connect the storage unit to the second communication interface, such that the second peripheral device reads and writes the first data of the storage unit according to the second protocol, and the second controller controls the first communication interface to enable the first peripheral device to charge the power module, and the second controller controls the second communication interface to enable the power module to supply the power to the second peripheral device.

9. The integrated electronic apparatus for data access, data transmission, and power management as claimed in claim 8, wherein in response to the power module supplying the power to the second peripheral device, the integrated electronic apparatus is in a host mode, and the second peripheral device is in a device mode, and in response to the second peripheral device reading and writing the first data, the integrated electronic apparatus is in the device mode, and the second peripheral device is in the host mode.

10. The integrated electronic apparatus for data access, data transmission, and power management as claimed in claim 1, wherein the storage unit comprises a secure digital memory card or an embedded multimedia card.

11. The integrated electronic apparatus for data access, data transmission, and power management as claimed in claim 1, wherein the first protocol comprises a universal serial bus (USB) mass storage class protocol, and the second protocol comprises an iPod accessory protocol.

12. An implementation method of an integrated electronic apparatus for data access, data transmission, and power management, the integrated electronic apparatus comprising a storage unit, a power module, a first communication interface, a second communication interface, a switch unit, a first controller, and a second controller, and the implementation method comprising:
S1, detecting whether the first communication interface is connected to a first peripheral device to determine a corresponding communication connection between the storage unit and the power module and the first peripheral device;
S2, detecting whether the second communication interface is connected to a second peripheral device to determine another corresponding communication connection between the storage unit and the power module and the second peripheral device;
S3, switching, by the switch unit, a connection state between the storage unit, the first peripheral device, and the second peripheral device according to detection results of the first communication interface and the second communication interface;
S4, controlling, by the second controller, a charging state and a powering state between the power module, the first peripheral device, and the second peripheral device according to the detection results of the first communication interface and the second communication interface;
S5, controlling, by the first controller, the first peripheral device to access first data corresponding to the storage unit according to a first protocol, and/or controlling, by the first controller, the second peripheral device to access the first data corresponding to the storage unit according to a second protocol; and
S6, controlling, by the second controller, the first peripheral device to charge the power module, and/or controlling, by the second controller, the power module to supply power to the second peripheral devices.

13. The implementation method of the integrated electronic apparatus for data access, data transmission, and power management as claimed in claim 12, wherein in the step S5, if the first peripheral device is connected to the first communication interface, the first controller controls the first peripheral device to read and write the first data of the storage unit according to the first protocol, and in the step S6, the second controller controls the first peripheral device to charge the power module.

14. The implementation method of the integrated electronic apparatus for data access, data transmission, and power management as claimed in claim 13, wherein the first peripheral device is in a host mode, and the integrated electronic apparatus is in a device mode.

15. The implementation method of the integrated electronic apparatus for data access, data transmission, and power management as claimed in claim 12, wherein in the step S5, if the second peripheral device is connected to the second communication interface, the first controller controls the second peripheral device to read and write the first data of the storage unit according to the second protocol, and in the step S6, the power module is controlled to supply the power to the second peripheral device.

16. The implementation method of the integrated electronic apparatus for data access, data transmission, and power management as claimed in claim 15, wherein if the power module supplies the power to the second peripheral device for charging, the integrated electronic apparatus is in a host mode and the second peripheral device is in a device mode, and if the second peripheral device reads and writes the first data, the integrated electronic apparatus is in the device mode and the second peripheral device is in host mode.

17. The implementation method of the integrated electronic apparatus for data access, data transmission, and power management as claimed in claim 12, wherein in the step S5, if the first peripheral device is connected to the first communication interface and the second peripheral device is connected to the second communication interface, the second controller controls the switch unit to enable the first peripheral device to extract second data of the second peripheral device according to the second protocol, and in the step S6, the second controller controls the first communication interface to enable the first peripheral device to charge the power module, and the second controller controls the second communication interface to enable the power module to supply the power to the second peripheral device.

18. The implementation method of the integrated electronic apparatus for data access, data transmission, and power management as claimed in claim 17, wherein the first peripheral device is in a host mode, and the second peripheral device is in a device mode.

19. The implementation method of the integrated electronic apparatus for data access, data transmission, and power management as claimed in claim 12, wherein in the step S5, if the first peripheral device is connected to the first communication interface and the second peripheral device is connected to the second communication interface, the first controller controls the switch unit to connect the storage unit to the second communication interface, such that the second peripheral device accesses the first data corresponding to the storage unit according to the second protocol, and in the step S6, the second controller controls the first communication interface to enable the first peripheral device to charge the power module, and the second controller controls the second communication interface to enable the power module to supply the power to the second peripheral device.

20. The implementation method of the integrated electronic apparatus for data access, data transmission, and power management as claimed in claim 19, wherein if the power module supplies the power to the second peripheral device, the integrated electronic apparatus is in a host mode and the second peripheral device is in a device mode, and if the second peripheral device reads and writes the first data, the integrated electronic apparatus is in the device mode, and the second peripheral device is in the host mode.
